(19) United States
(12) Patent Application Publication
(10) Pub. No.: US 2025/0106844 A1
(43) Pub. Date: Mar. 27, 2025

(54) DESIGN OF DELAY-AWARE BSR FOR XR APPLICATIONS

(71) Applicant: Telefonaktiebolaget LM Ericsson (publ), Stockholm (SE)

(72) Inventors: Du Ho KANG, Sollentuna (SE); Jose Luis PRADAS, Stockholm (SE); Richard TANO, Stockholm (SE); Jonathan PALM, Luleå (SE)

(21) Appl. No.: 18/725,484

(22) PCT Filed: Dec. 28, 2022
(86) PCT No.: PCT/IB2022/062849

§ 371 Date: Jun. 28, 2024

Related U.S. Application Data
(60) Provisional application No. 63/295,214, filed on Dec. 30, 2021.

(51) Int. Cl. H04W 72/1268; H04W 28/02; H04W 72/12; H04W 72/543

(52) U.S. Cl. CPC H04W 72/1268; H04W 28/0278; H04W 72/1221; H04W 72/543

(57) ABSTRACT

A method and apparatus are disclosed. A network node is configured to communicate with a wireless device. The network node is configured to receive a buffer status report from the wireless device which includes queue information for a first protocol data unit (PDU) set, where the first PDU set includes at least one queued packet. The network node is configured to determine a scheduling grant for the wireless device based on the queue information and at least one PDF left value associated with the first PDU set. The network node is configured to cause transmission of the scheduling grant to the wireless device, and to receive at least one uplink transmission of the at least one queued packet from the wireless device according to the scheduling grant.

### FIELD

The present disclosure relates to wireless communications, and in particular, to delay-aware buffer status reporting in wireless communications.

### BACKGROUND

The Third Generation Partnership Project (3GPP) 5G standard is the fifth generation standard of mobile communications, addressing a wide range of use cases from enhanced mobile broadband (eMBB) to ultra-reliable low-latency communications (URLLC) to massive machine type communications (mMTC). 5G (also referred to as New Radio (NR)) includes the New Radio (NR) access stratum interface and the 5G Core Network (5GC). The NR physical and higher layers are reusing parts of the 4G (4th Generation, also referred to as Long Term Evolution (LTE)) specification, and to that add needed components for new use cases.

Low-latency high-rate applications such as extended Reality (XR) and cloud gaming are use cases in the 5G era. XR may refer to all real-and-virtual combined environments and human-machine interactions generated by computer technology and wearables. It is an umbrella term for different types of realities including Virtual Reality (VR), Augmented Reality (AR), Mixed Reality (MR), and the areas interpolated among them. The levels of virtuality range from partially sensory inputs to fully immersive VR.

5G NR is designed to support applications demanding high rate and low latency in line with the requirements posed by the support of XR and cloud gaming applications in NR networks. The 3GPP has conducted studies on XR evaluations for NR. Some objectives of the studies are to identify the traffic model for each application of interest, the evaluation methodology and the key performance indicators of interest for relevant deployment scenarios, and to carry out performance evaluations accordingly in order to investigate possible standardization enhancements.

Low-latency applications like XR and cloud gaming may require bounded latency, not necessarily ultra-low latency. The end-to-end latency budget may be in the range of 20-80 ms, which may need to be distributed over several components including application processing latency, transport latency, radio link latency, etc. For these applications, short transmission time intervals (TTIs) or mini-slots targeting ultra-low latency may not be effective.

FIG. 1 is a diagram of an example of frame latency measured over a radio access network (RAN), excluding application & core network latencies. FIG. 1 depicts several frame latency spikes in the RAN. The latency spikes occur due to instantaneous shortage of radio resources or inefficient radio resource allocation in response to varying frame size. The sources for the latency spikes may include queuing delay, time-varying radio environments, time-varying frame sizes, among others.

In addition to bounded latency requirements, applications like XR and cloud gaming also require high rate transmission. This can be seen from the large frame sizes originated from this type of traffic. The typical frame sizes may range from tens of kilobytes to hundreds of kilobytes. The frame arrival rates may be 60 or 120 frames per second (fps). As an example, a frame size of 100 kilobytes and a frame arrival rate of 120 fps can lead to a rate requirement of 95.8 Mbps.

A large video frame is usually fragmented into smaller IP packets and transmitted as several transport blocks (TBs) over several transmission time intervals (TTIs) in the RAN. FIG. 2 is a diagram of an example of the cumulative distribution functions of the number of transport blocks required to deliver a video frame with size ranging from 20 KB to 300 KB. For example, FIG. 2 shows that for delivering the frames with a size of 200 KB each, the median number of needed TBs is 5.

The characteristics of XR traffic arrival are quite distinct from typical web-browsing and VoIP (voice over internet protocol) traffic, as shown in FIG. 3. The x-axis of the graph in FIG. 3 represents time and the y-axis represents a quantity of data to be sent. It is expected that the arrival time of XR traffic is quasi-periodic and largely predictable, like VoIP. However, XR traffic's data size is an order of magnitude larger than that of VoIP, as discussed above. In addition, similar to web-browsing traffic, the data size of XR traffic is different at every application protocol data unit (PDU) arrival instance, e.g., due to dynamics of content and human motion.

### Buffer Status Report (BSR) for Uplink Dynamic Grant

The wireless device (WD) reports to the network the buffer status waiting for transmission in the MAC Control Element (CE) Buffer Status Report (BSR). There are 4 different BSR formats which WDs can send to the network: a Short BSR format (fixed size); a Short Truncated BSR format (fixed size); a Long Truncated BSR format (variable size); and a Long BSR format (variable size). The short BSR and short truncated BSR format are shown in FIG. 4. The long BSR and long truncated BSR format are shown in FIG. 5.

There are three types of BSRs: regular BSR, periodic BSR, and padding BSR.

The regular BSR is triggered if uplink (UL) data, for a logical channel which belongs to a logical channel group (LCG), becomes available to the MAC entity; and either this UL data belongs to a logical channel with higher priority than the priority of any logical channel containing available UL data which belong to any LCG; or none of the logical channels which belong to an LCG contains any available UL data. When more than one LCG has data available for transmission, then the WD uses the long BSR format and reports all LCGs which have data. However, if only one LCG has data, the short BSR format is used.

The periodic BSR is configured by the network. When configured, the WD periodically reports the BSR. When more than one LCG has data available for transmission, then the WD uses the long BSR format and reports all LCGs which have data. However, if only one LCG has data, the short BSR format is used.

The padding BSR is an opportunistic method to provide buffer status information to the network when the MAC PDU would contain a number of padding bits equal to or larger than one of the BSR formats. In this case, the WD would add the padding BSR replacing the corresponding padding bits. In this case, the BSR format to be used depends on the number of padding bits, the number of logical channels which have data for transmissions, and the size of the BSR format. When more than one LCG has data for transmission, one of the following three formats is used: the short truncated BSR, the long BSR, or the long truncated BSR. The selection of the BSR format depends on the number of available padding bits. When only one LCG has data for transmission, then the short BSR format is used.

A principle of all forementioned BSR types is having information of data size in a buffer with static prioritization indication included in LCG. However, in an XR application which may be very delay-sensitive and at the same time, video frame size and remaining latency budget may be time-varying, the Legacy BSR may not be sufficient for appropriate delay-aware scheduling to prioritize grant allocation. “Legacy,” as used herein, may generally refer to a procedure/format known in the art at the time of the filing of the present disclosure and/or may be a procedure/format upon which an improvement is made.

FIGS. 6-9 illustrate examples of potential issues of legacy BSR for XR applications. FIGS. 6-7 illustrate an example scenario involving a single user with multiple LCIDs where only X′ (<X) bits are granted based on legacy long BSR for LCID based prioritization. FIGS. 8-9 illustrate an example scenario involving multiple users (WD1 and WD2) based on legacy short BSR where WD2 has only partial X′ (<X) bits granted.

In particular, FIGS. 6 and 7 depict an example legacy BSR for a single WD (“WD1”) with three LCIDs with different PDB. Assume LCID 1 and LCID 2 received ADUs from an XR application, e.g., video and pose with different PDB (packet delay budget). Due to the different traffic characteristics of each flow, the different arrival and/or grant time, there is a different amount of remaining bits (X, Y, M, N, W) in each of the buffers. In addition, at a given LCID, each set of remaining bits also has a different amount of remaining PDB, denoted as PDB_left. Each shading pattern corresponds to a different PDB_left (e.g., different buckets representing different time windows/time ranges of PDB_left values). The legacy LCID prioritization process, i.e., the WD process to select the LCIDs from which data will be taken from their buffer, does not consider delay. When the grant is received, the WD selects suitable LCIDs that meet the requirements to use and transmit in the grant provided by the network. After that, the order data is selected from the LCIDs based on a priority-based order. The priority of each LCID is configured by radio resource control (RRC). In this example, LCID1 is the highest priority LCID and, thus, bits of Y, M, N will be taken before data from LCID2. This may lead to fewer than X bits (X′<X) being taken from the buffer of LCID2. In FIGS. 8 and 9, a similar issue as described above is expected for a multi-user scenario.

### SUMMARY

Existing BSR includes only the buffer size per LCG, i.e., the aggregated buffer size in a set of logical channel identities (LCIDs). This will only indicate to a network a time-varying size of application data, e.g., video frame. However, different application data may have a time-varying latency budget due to a different queuing delay, grant timing, and/or transmission time so that a network should be able to consider those to prioritize and differentiate a grant size for different users in the same cell, for different flows, or different LCIDs in the same user. The legacy LCID prioritization process, i.e., the WD process to select the LCIDs from which data will be taken from their buffer, does not consider delay, however. For example, in the multi-user scenario depicted in FIGS. 8 and 9, without the network having knowledge of delay information (e.g., PDB_left information), a network may equally allocate resources between WD1 and WD2, so that fewer than X bits will be transmitted, while all of the less urgent M bits are transmitted from WD1. Hence, existing systems fail to adequately communicate and consider delay information.

Some embodiments advantageously provide methods and apparatuses for delay-aware buffer status reporting.

In some embodiments, a network node is configured to communicate with a wireless device (WD) (also referred to as a “UE” or “user equipment”). In some embodiments, the network node is configured to receive a buffer status report from the WD. In some embodiments, the buffer status report is based on: a queue duration of at least one queued data packet, and a packet data buffer (PDB) duration of a logical channel associated with the at least one queued data packet. In some embodiments, the network node is further configured to determine a scheduling grant to the WD based on the buffer status report.

In some embodiments, the buffer status report includes at least one delay group index. In some embodiments, each of the at least one delay group index is associated with: at least one time value, and at least one queued data packet.

In some embodiments, the buffer status report includes a corresponding buffer status parameter for each of the at least one delay group index. In some embodiments, the buffer status parameter is based on a total size of queued data packets associated with each of the at least one delay group index.

In some embodiments, the scheduling grant is based on the total size of queued data packets associated with the delay group index having a lowest time value.

In some embodiments, a method is implemented in a network node that is configured to communicate with a wireless device (WD). In some embodiments, the method includes receiving a buffer status report from the WD. In some embodiments, the buffer status report is based on: a queue duration of at least one queued data packet, and a packet data buffer (PDB) duration of a logical channel associated with the at least one queued data packet. In some embodiments, the method includes determining a scheduling grant to the WD based on the buffer status report.

In some embodiments, the buffer status report includes at least one delay group index. In some embodiments, each of the at least one delay group index is associated with: at least one time value; and at least one queued data packet.

In some embodiments, the buffer status report includes a corresponding buffer status parameter for each of the at least one delay group index. In some embodiments, the buffer status parameter is based on a total size of queued data packets associated with each of the at least one delay group index.

In some embodiments, the scheduling grant is based on the total size of queued data packets associated with the delay group index having a lowest time value.

In some embodiments, a wireless device (WD) is configured to communicate with a network node. In some embodiments, the WD is configured to determine a queue duration for at least one of a plurality of queued data packets. In some embodiments, each of the plurality of queued data packets is associated with a logical channel of a plurality of logical channels. In some embodiments, each of the plurality of logical channels is associated with a packet data buffer (PDB) duration. In some embodiments, the WD is configured to send a buffer status report to the network node. In some embodiments, the buffer status report is based on: the determined queue duration of the at least one queued data packet, and the PDB duration of the logical channel associated with the at least one queued data packet.

In some embodiments, the buffer status report includes at least one delay group index. In some embodiments, the at least one delay group index is associated with at least one time value.

In some embodiments, the WD is further configured to associate the at least one queued data packet to a corresponding delay group index. In some embodiments, the associating includes: determining a difference between the queue duration of the at least one queued data packet and the PDB duration of the logical channel associated with the at least one queued data packet, comparing the difference to the at least one time value of at least one delay group index, and mapping the at least one queued data packet to a delay group index based on the comparison.

In some embodiments, for each delay group index included in the buffer status report, the buffer status report includes a corresponding buffer status parameter. In some embodiments, the buffer status parameter is based on a total size of queued data packets associated with the delay group index.

In some embodiments, the buffer status report includes at least one of: a logical channel indication and a logical channel group indication.

In some embodiments, a method is implemented in a wireless device (WD) that is configured to communicate with a network node. In some embodiments, the method includes determining a queue duration for at least one of a plurality of queued data packets. In some embodiments, each of the plurality of queued data packets is associated with a logical channel of a plurality of logical channels. In some embodiments, each of the plurality of logical channels is associated with a packet data buffer (PDB) duration. In some embodiments, the method includes sending a buffer status report to the network node. In some embodiments, the buffer status report is based on: the determined queue duration of the at least one queued data packet, and the PDB duration of the logical channel associated with the at least one queued data packet.

In some embodiments, the buffer status report includes at least one delay group index. In some embodiments, the at least one delay group index is associated with at least one time value.

In some embodiments, the method further includes associating the at least one queued data packet to a corresponding delay group index. In some embodiments, the associating includes determining a difference between the queue duration of the at least one queued data packet and the PDB duration of the logical channel associated with the at least one queued data packet, comparing the difference to the at least one time value of at least one delay group index, and mapping the at least one queued data packet to a delay group index based on the comparison.

In some embodiments, for each delay group index included in the buffer status report, the buffer status report includes a corresponding buffer status parameter. In some embodiments, the buffer status parameter is based on a total size of queued data packets associated with the delay group index.

In some embodiments, the buffer status report includes at least one of: a logical channel indication and a logical channel group indication.

According to an aspect of the present disclosure, a network node configured to communicate with a wireless device (WD) in a wireless communication system is provided. The network node is configured to receive a buffer status report from the WD, the buffer status report including queue information for a first protocol data unit (PDU) set, the first PDU set including at least one queued packet. The network node is configured to determine a scheduling grant for the WD based on the queue information and at least one packet delay budget (PDB) left value associated with the first PDU set. The network node is configured to cause transmission of the scheduling grant to the WD, and receive at least one uplink transmission of the at least one queued packet from the WD according to the scheduling grant.

According to one or more embodiments of this aspect, at least one PDB left value corresponds to a difference between at least one queue duration of the at least one queued packet and at least one PDB associated the first PDU set. According to one or more embodiments of this aspect, the queue information included in the buffer status report includes at least one of: at least one queue duration corresponding to the at least one queued packet, at least one PDB left value associated with the at least one queued packet, at least one PDB left value associated with the first PDU set, at least one delay group index associated with the at least one queued packet, the at least one delay group index corresponding to at least one range of PDB left values, and at least one total packet size value associated with the at least one delay group index. According to one or more embodiments of this aspect, the buffer status report includes a corresponding buffer status parameter for each of the at least one delay group index, the buffer status parameter being based on a total size of queued packets associated with each of the at least one delay group index. According to one or more embodiments of this aspect, the scheduling grant is based on the total size of queued packets associated with the delay group index having a lowest time value. According to one or more embodiments of this aspect, the network node is further configured to receive at least one other buffer status report from at least one other WD, and the determining of the scheduling grant for the WD being further based on the at least one other buffer status report and at least one packet delay budget (PDB) left value associated with at least one PDU set of the at least one other WD. According to one or more embodiments of this aspect, the at least one PDB is associated with at least one of: at least one logical channel, at least one buffer, or at least one quality of service, QoS, requirement.

According to another aspect of the present disclosure, a method implemented in a network node is provided. The method includes receiving a buffer status report from the WD, the buffer status report including queue information for a first protocol data unit (PDU) set, the first PDU set including at least one queued packet, determining a scheduling grant for the WD based on the queue information and at least one packet delay budget (PDB) left value associated with the first PDU set, causing transmission of the scheduling grant to the WD, and receiving at least one uplink transmission of the at least one queued packet from the WD according to the scheduling grant.

According to one or more embodiments of this aspect, the at least one PDB left value corresponds to a difference between at least one queue duration of the at least one queued packet and at least one PDB associated the first PDU set. According to one or more embodiments of this aspect, the queue information included in the buffer status report includes at least one of: at least one queue duration corresponding to the at least one queued packet, at least one PDB left value associated with the at least one queued packet, at least one PDB left value associated with the first PDU set, at least one delay group index associated with the at least one queued packet, the at least one delay group index corresponding to at least one range of PDB left values, and at least one total packet size value associated with the at least one delay group index. According to one or more embodiments of this aspect, the buffer status report includes a corresponding buffer status parameter for each of the at least one delay group index, the buffer status parameter being based on a total size of queued packets associated with each of the at least one delay group index. According to one or more embodiments of this aspect, the scheduling grant is based on the total size of queued packets associated with the delay group index having a lowest time value. According to one or more embodiments of this aspect, the method further comprises receiving at least one other buffer status report from at least one other WD, and the determining of the scheduling grant for the WD being further based on the at least one other buffer status report and at least one packet delay budget (PDB) left value associated with at least one PDU set of the at least one other WD. According to one or more embodiments of this aspect, the at least one PDB is associated with at least one of: at least one logical channel, at least one buffer, or at least one quality of service, QoS, requirement.

According to another aspect of the present disclosure, a wireless device configured to communicate with a network node in a wireless communication system is provided. The wireless device is configured to determine a buffer status report, the buffer status report including queue information for a first protocol data unit (PDU) set, the first PDU set including at least one queued packet. The wireless device is configured to receive, from the network node, a scheduling grant based on the queue information and at least one packet delay budget (PDB) left value associated with the first PDU set. The wireless device is configured to cause transmission of at least one uplink transmission of the at least one queued packet according to the scheduling grant.

According to one or more embodiments of this aspect, the at least one PDB left value corresponds to a difference between at least one queue duration of the at least one queued packet and at least one PDB associated with the first PDU set. According to one or more embodiments of this aspect, the queue information included in the buffer status report includes at least one of: at least one queue duration corresponding to at least one queued packet, at least one PDB left value associated with the at least one queued packet, at least one PDB left value associated with the first PDU set, at least one delay group index associated with the at least one queued packet, the at least one delay group index corresponding to at least one range of PDB left values, and at least one total packet size value associated with the at least one delay group index. According to one or more embodiments of this aspect, the buffer status report includes a corresponding buffer status parameter for each of the at least one delay group index, the buffer status parameter being based on a total size of queued packets associated with each of the at least one delay group index. According to one or more embodiments of this aspect, the scheduling grant for the WD is based on at least one other buffer status report associated with at least one other WD and at least one packet delay budget (PDB) left value associated with at least one PDU set of the at least one other WD. According to one or more embodiments of this aspect, the at least one PDB is associated with at least one of: at least one logical channel, at least one buffer, or at least one quality of service, QoS, requirement.

According to another aspect of the present disclosure, a method implemented in a wireless device is provided. The method includes determining a buffer status report, the buffer status report including queue information for a first protocol data unit (PDU) set, the first PDU set including at least one queued packet, receiving, from the network node, a scheduling grant based on the queue information and at least one packet delay budget (PDB) left value associated with the first PDU set, and causing transmission of at least one uplink transmission of the at least one queued packet according to the scheduling grant.

According to one or more embodiments of this aspect, the at least one PDB left value corresponds to a difference between at least one queue duration of the at least one queued packet and at least one PDB associated with the first PDU set. According to one or more embodiments of this aspect, the queue information included in the buffer status report includes at least one of: at least one queue duration corresponding to at least one queued packet, at least one PDB left value associated with the at least one queued packet, at least one PDB left value associated with the first PDU set, at least one delay group index associated with the at least one queued packet, the at least one delay group index corresponding to at least one range of PDB left values, and at least one total packet size value associated with the at least one delay group index. According to one or more embodiments of this aspect, the buffer status report includes a corresponding buffer status parameter for each of the at least one delay group index, the buffer status parameter being based on a total size of queued packets associated with each of the at least one delay group index. According to one or more embodiments of this aspect, the scheduling grant for the WD is based on at least one other buffer status report associated with at least one other WD and at least one packet delay budget (PDB) left value associated with at least one PDU set of the at least one other WD. According to one or more embodiments of this aspect, the at least one PDB is associated with at least one of: at least one logical channel, at least one buffer, or at least one quality of service, QoS, requirement.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a graph showing an example frame latency measured over the Radio Access Network (RAN);

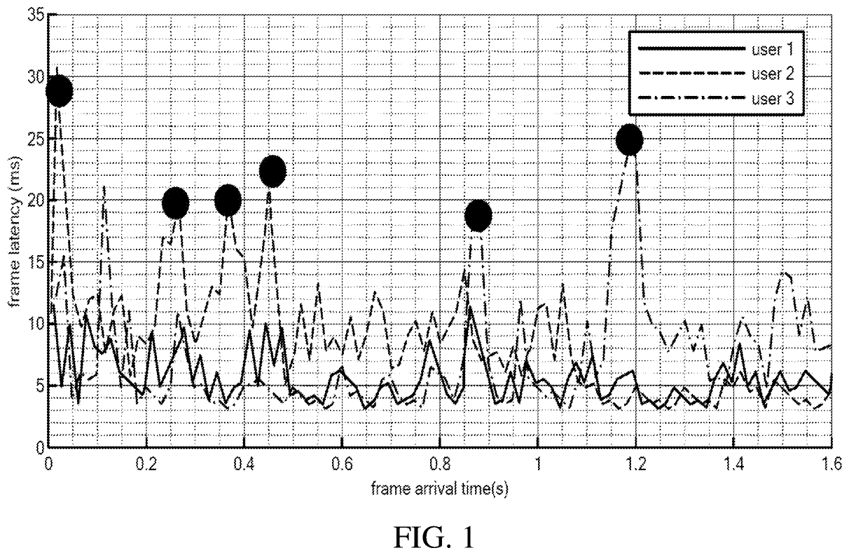

FIG. 2 is a graph showing an example of cumulative distribution functions of the number of transport blocks required to deliver a video frame with size ranging from 20 KB to 300 KB;

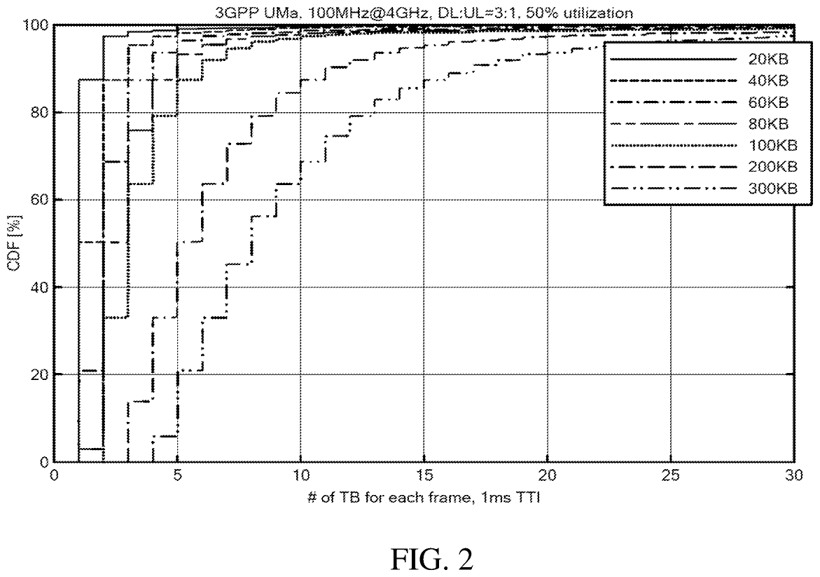

FIG. 3 is a graph showing an example of extended reality (XR) traffic characteristics compared to voice-over-IP (VOIP) and Web-browsing traffic;

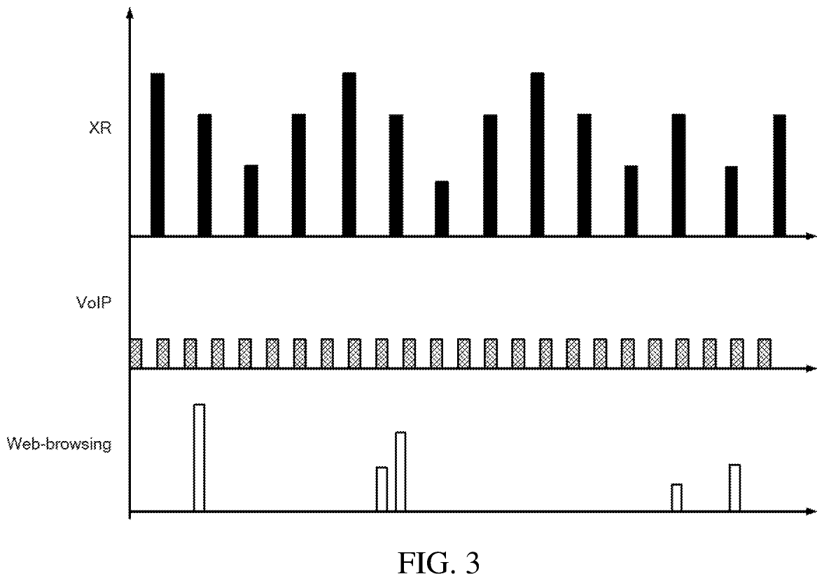

FIG. 4 is a diagram illustrating an example MAC Control Element (CE) Buffer Status Report (BSR) format;

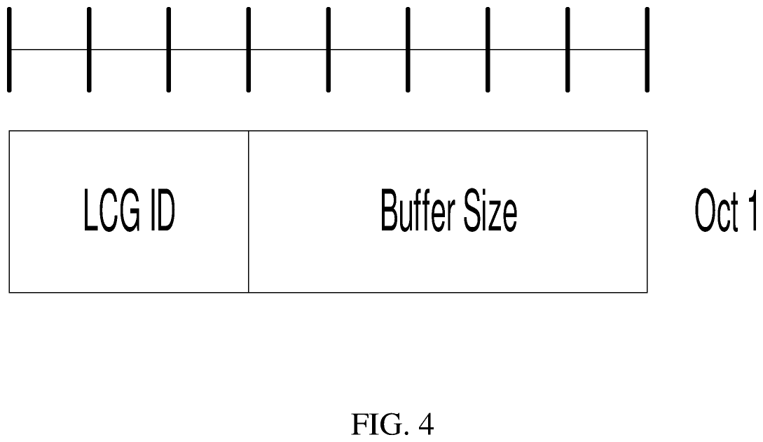

FIG. 5 is a diagram illustrating an example BSR format;

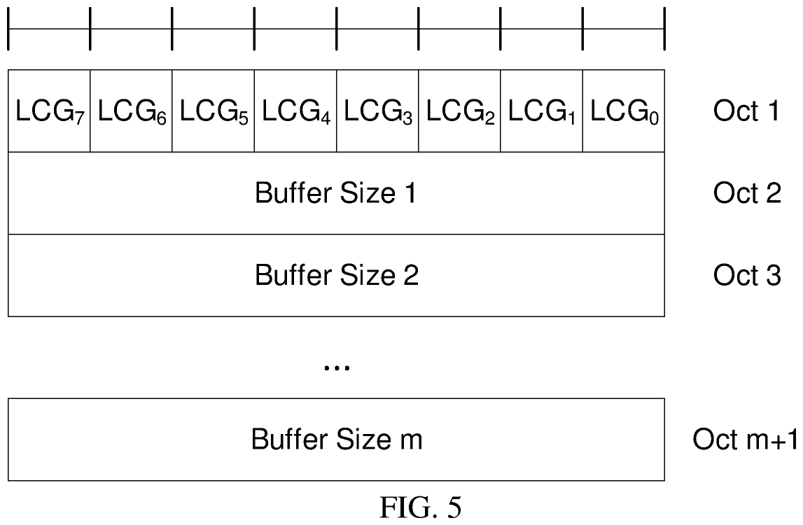

FIG. 6 is a diagram illustrating an example single-user transmission scenario;

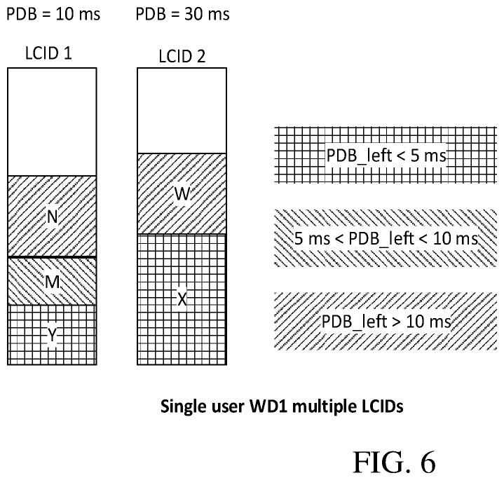

FIG. 7 is a diagram illustrating an example single-user legacy grant;

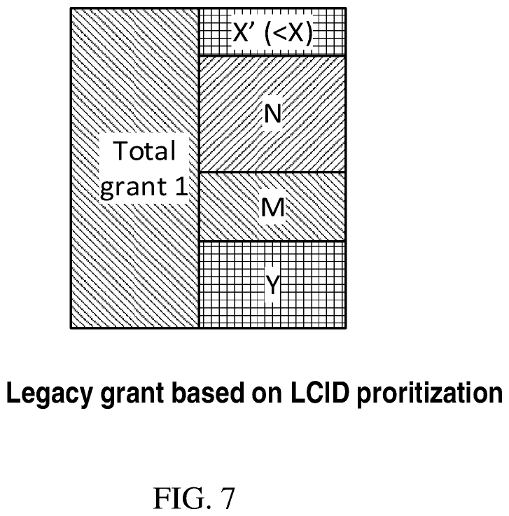

FIG. 8 is a diagram illustrating an example multi-user transmission scenario;

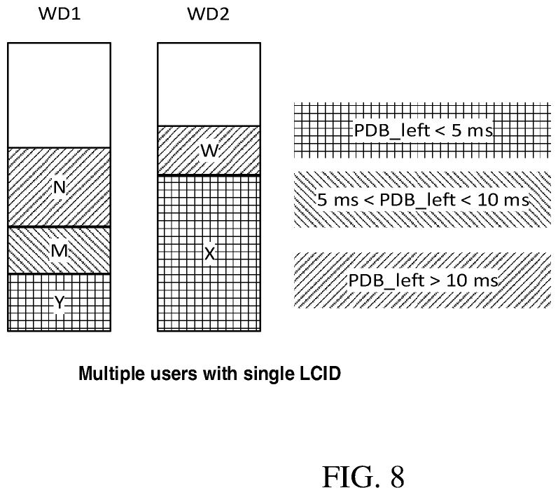

FIG. 9 is a diagram illustrating an example multi-user legacy grant;

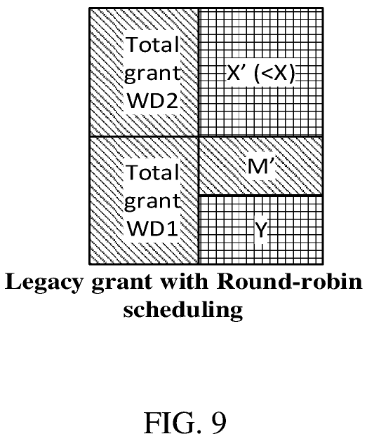

FIG. 10 is a schematic diagram of an example network architecture according to the principles in the present disclosure;

FIG. 11 is a block diagram of a network node communicating with a wireless device over an at least partially wireless connection according to some embodiments of the present disclosure;

FIG. 12 is a flowchart illustrating an example process according to some embodiments of the present disclosure;

FIG. 13 is a flowchart illustrating another example process according to some embodiments of the present disclosure;

FIG. 14 is a flowchart illustrating another example process according to some embodiments of the present disclosure;

FIG. 15 is a flowchart illustrating another example process according to some embodiments of the present disclosure;

FIG. 16 is a diagram illustrating an example transmission scenario according to some embodiments of the present disclosure;

FIG. 17 is another diagram illustrating an example BSR format according to some embodiments of the present disclosure;

FIG. 18 is another diagram illustrating another example BSR format according to some embodiments of the present disclosure;

FIG. 19 is another diagram illustrating another example BSR format according to some embodiments of the present disclosure;

FIG. 20 is another diagram illustrating another example BSR format according to some embodiments of the present disclosure;

FIG. 21 is another diagram illustrating another example BSR format according to some embodiments of the present disclosure;

FIG. 22 is another diagram illustrating an example transmission scenario according to some embodiments of the present disclosure;

FIG. 23 is another diagram illustrating example scheduling grants according to some embodiments of the present disclosure;

FIG. 24 is another diagram illustrating an example transmission scenario according to some embodiments of the present disclosure;

FIG. 25 is another diagram illustrating example scheduling grants according to some embodiments of the present disclosure;

FIG. 26 is a diagram illustrating a MAC CE configuration message format according to some embodiments of the present disclosure; and

FIG. 27 is another diagram illustrating another MAC CE configuration message format according to some embodiments of the present disclosure.

### DETAILED DESCRIPTION

Before describing in detail example embodiments, it is noted that the embodiments reside primarily in combinations of apparatus components and processing steps related to delay-aware buffer status reporting. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3^{rd} party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

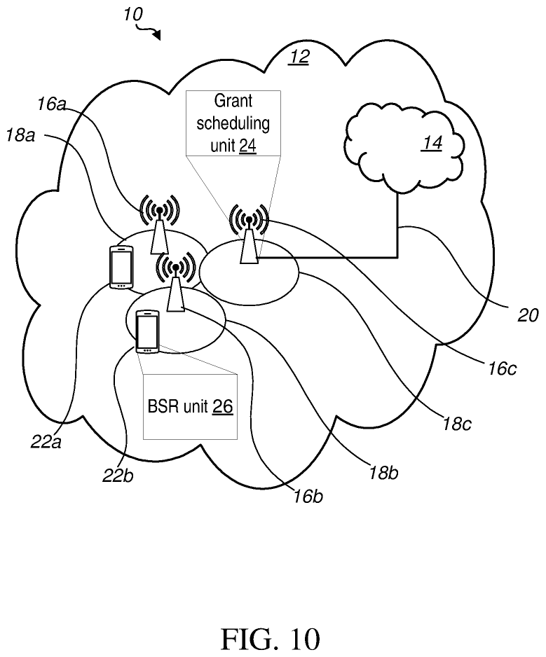

Referring to the drawing figures, in which like elements are referred to by like reference numerals, there is shown in FIG. 10 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

A network node 16 (eNB or gNB) is configured to include a grant scheduling unit 24 which is configured to perform one or more network node 16 functions as described herein such as with respect to scheduling grants for uplink transmission for WD 22, e.g., based on buffer status reports (BSRs) received from WD 22. A wireless device 22 is configured to include a BSR unit 26 which is configured to perform one or more wireless device 22 functions as described herein such as with respect to determining buffer status reports based on delay information associated with queued data packets and logical channels of WD 22.

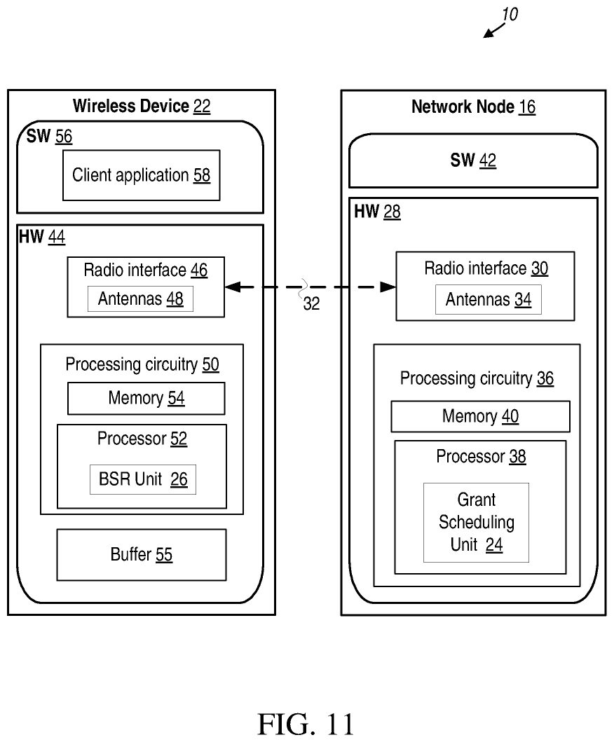

Example implementations, in accordance with an embodiment, of the WD 22 and network node 16 discussed in the preceding paragraphs will now be described with reference to FIG. 11.

The communication system 10 includes a network node 16 provided in a communication system 10 and including hardware 28 enabling it to communicate with the WD 22. The hardware 28 may include a radio interface 30 for setting up and maintaining at least a wireless connection 32 with a WD 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves. In one or more embodiments, network node 16 may include a communication interface (not shown) for communication with other entities such as core network entities, and/or communicating over the backhaul network.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16. For example, processing circuitry 36 of the network node 16 may include grant scheduling unit 24 which is configured to perform one or more network node 16 functions as described herein such as with respect to scheduling grants for uplink transmission for WD 22, e.g., based on buffer status reports (BSRs) received from WD 22.

The communication system 10 further includes the WD 22 already referred to. The WD 22 may have hardware 44 that may include a radio interface 46 configured to set up and maintain a wireless connection 32 with a network node 16 serving a coverage area 18 in which the WD 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Further, hardware 44 includes one or more buffers 55 (collectively referred to as buffer 55). Buffer 55 is configured to temporarily store data queued for transmission. Buffer 55 may be a module/component in communication with processing circuitry 50 and/or radio interface 46, and/or may be part of processing circuitry 50 and/or radio interface 46. Buffer 55 may be one or more locations in memory 54.

The WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22. For example, the processing circuitry 50 of the wireless device 22 may include BSR unit 26 which is configured to perform one or more wireless device 22 functions as described herein such as with respect to determining buffer status reports based on delay information associated with queued data packets and logical channels of WD 22.

In some embodiments, the inner workings of the network node 16 and WD 22 may be as shown in FIG. 11 and independently, the surrounding network topology may be that of FIG. 10.

The wireless connection 32 between the WD 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 10 and 11 show various “units” such as grant scheduling unit 24 and BSR unit 26, as being within a respective processor, it is contemplated that these units may be implemented such that a portion of the unit is stored in a corresponding memory within the processing circuitry. In other words, the units may be implemented in hardware or in a combination of hardware and software within the processing circuitry.

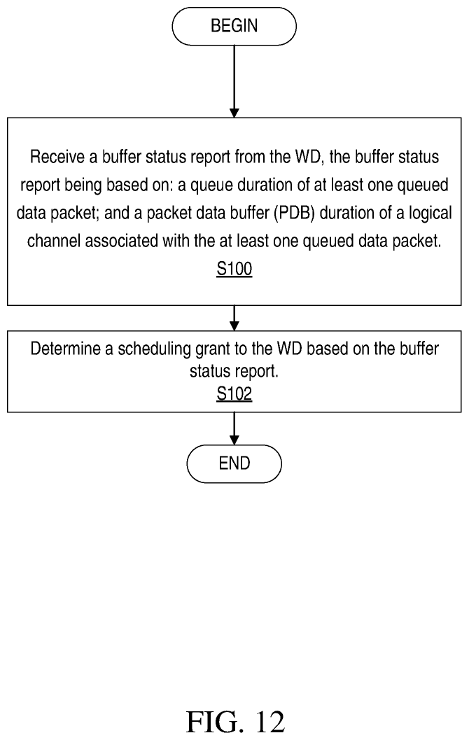

FIG. 12 is a flowchart of an example process in a network node 16 for according to some embodiments of the present disclosure. One or more blocks described herein may be performed by one or more elements of network node 16 such as by one or more of processing circuitry 36 (including the grant scheduling unit 24), processor 38, and/or radio interface 30. Network node 16 is configured to receive (Block S100) a buffer status report from the WD 22 where the buffer status report is based on: a queue duration of at least one queued data packet; and a PDB duration of a logical channel associated with the at least one queued data packet. Network node 16 is further configured to determine (Block S102) a scheduling grant to the WD 22 based on the buffer status report.

In some embodiments, the buffer status report includes at least one delay group index, each of the at least one delay group index being associated with: at least one time value, and at least one queued data packet.

In some embodiments, the buffer status report includes a corresponding buffer status parameter for each of the at least one delay group index, the buffer status parameter being based on a total size of queued data packets associated with each of the at least one delay group index.

In some embodiments, the scheduling grant is based on the total size of queued data packets associated with the delay group index having a lowest time value.

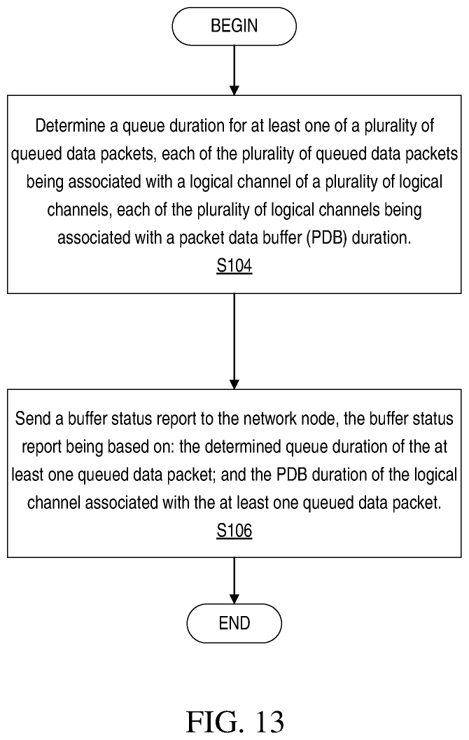

FIG. 13 is a flowchart of an example process in a wireless device 22 according to some embodiments of the present disclosure. One or more blocks described herein may be performed by one or more elements of wireless device 22 such as by one or more of processing circuitry 50 (including the BSR unit 26), processor 52, and/or radio interface 46. Wireless device 22 is configured to determine (Block S104) a queue duration for at least one of a plurality of queued data packets where each of the plurality of queued data packets is associated with a logical channel of a plurality of logical channels, each of the plurality of logical channels being associated with a PDB duration. Wireless device 22 is further configured to send (Block S106) a buffer status report to the network node 16 where the buffer status report is based on: the determined queue duration of the at least one queued data packet, and the PDB duration of the logical channel associated with the at least one queued data packet. The buffer status report is associated with buffer 55.

In some embodiments, the buffer status report includes at least one delay group index where the at least one delay group index is associated with at least one time value.

In some embodiments, wireless device 22 is further configured to associate the at least one queued data packet to a corresponding delay group index. The associating includes determining a difference between the queue duration of the at least one queued data packet and the PDB duration of the logical channel associated with the at least one queued data packet, comparing the difference to the at least one time value of at least one delay group index, and mapping the at least one queued data packet to a delay group index based on the comparison.

In some embodiments, for each delay group index included in the buffer status report where the buffer status report includes a corresponding buffer status parameter and the buffer status parameter is based on a total size of queued data packets associated with the delay group index.

In some embodiments, the buffer status report includes at least one of: a logical channel indication and a logical channel group indication.

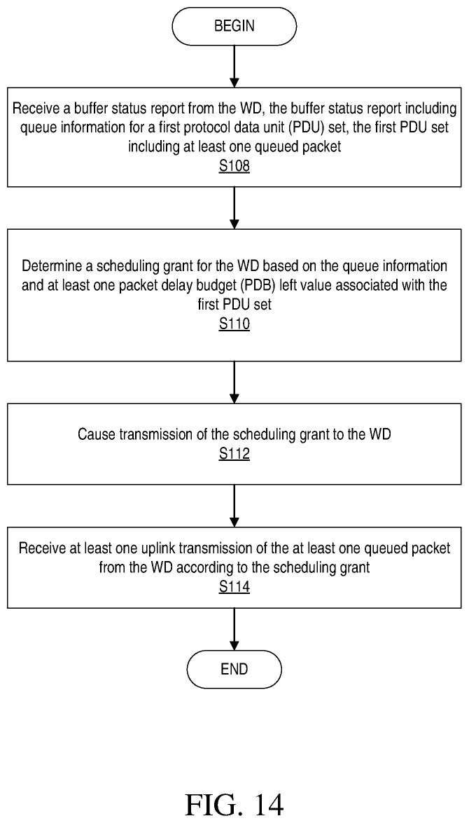

FIG. 14 is a flowchart of another example process in a network node 16 for according to some embodiments of the present disclosure. One or more blocks described herein may be performed by one or more elements of network node 16 such as by one or more of processing circuitry 36 (including the grant scheduling unit 24), processor 38, and/or radio interface 30. Network node 16 is configured to receive (Block S108) a buffer status report from the WD (22), the buffer status report including queue information for a first protocol data unit (PDU) set, the first PDU set including at least one queued packet. Network node 16 is configured to determine (Block S110) a scheduling grant for the WD (22) based on the queue information and at least one packet delay budget (PDB) left value associated with the first PDU set. Network node 16 is configured to cause transmission (Block S112) of the scheduling grant to the WD (22). Network node 16 is configured to receive (Block S114) at least one uplink transmission of the at least one queued packet from the WD (22) according to the scheduling grant.

In some embodiments, the at least one PDB left value corresponds to a difference between at least one queue duration of the at least one queued packet and at least one PDB associated the first PDU set. In some embodiments, the queue information included in the buffer status report includes at least one of at least one queue duration corresponding to the at least one queued packet, at least one PDB left value associated with the at least one queued packet, at least one PDB left value associated with the first PDU set, at least one delay group index associated with the at least one queued packet, the at least one delay group index corresponding to at least one range of PDB left values, and at least one total packet size value associated with the at least one delay group index. In some embodiments, the buffer status report includes a corresponding buffer status parameter for each of the at least one delay group index, the buffer status parameter being based on a total size of queued packets associated with each of the at least one delay group index. In some embodiments, the scheduling grant is based on the total size of queued packets associated with the delay group index having a lowest time value. In some embodiments, the network node 16 is further configured to receive at least one other buffer status report from at least one other WD 22, and the determining of the scheduling grant for the WD 22 is further based on the at least one other buffer status report and at least one packet delay budget (PDB) left value associated with at least one PDU set of the at least one other WD 22. In some embodiments, the at least one PDB is associated with at least one of at least one logical channel, at least one buffer, or at least one quality of service, QoS, requirement.

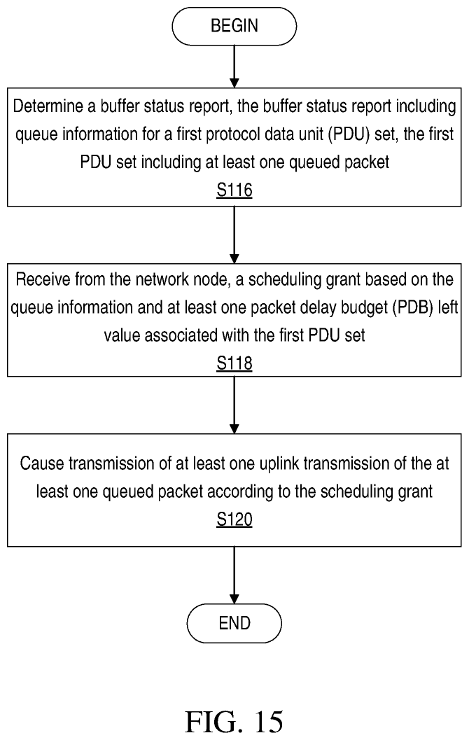

FIG. 15 is a flowchart of another example process in a wireless device 22 according to some embodiments of the present disclosure. One or more blocks described herein may be performed by one or more elements of wireless device 22 such as by one or more of processing circuitry 50 (including the BSR unit 26), processor 52, and/or radio interface 46. Wireless device 22 is configured to determine (Block S116) a buffer status report, the buffer status report including queue information for a first protocol data unit (PDU) set, the first PDU set including at least one queued packet. Wireless device 22 is further configured to receive (Block S118), from the network node 16, a scheduling grant based on the queue information and at least one packet delay budget (PDB) left value associated with the first PDU set. Wireless device 22 is further configured to cause transmission (Block S120) of at least one uplink transmission of the at least one queued packet according to the scheduling grant.

In some embodiments, the at least one PDB left value corresponds to a difference between at least one queue duration of the at least one queued packet and at least one PDB associated with the first PDU set. In some embodiments, the queue information included in the buffer status report includes at least one of at least one queue duration corresponding to at least one queued packet, at least one PDB left value associated with the at least one queued packet, at least one PDB left value associated with the first PDU set, at least one delay group index associated with the at least one queued packet, the at least one delay group index corresponding to at least one range of PDB left values, and at least one total packet size value associated with the at least one delay group index. . . . In some embodiments, the buffer status report includes a corresponding buffer status parameter for each of the at least one delay group index, the buffer status parameter being based on a total size of queued packets associated with each of the at least one delay group index. In some embodiments, the scheduling grant for the WD 22 is based on at least one other buffer status report associated with at least one other WD 22 and at least one packet delay budget (PDB) left value associated with at least one PDU set of the at least one other WD 22. In some embodiments, the at least one PDB is associated with at least one of at least one logical channel, at least one buffer, or at least one quality of service, QoS, requirement.

Having described the general process flow of arrangements of the disclosure and having provided examples of hardware and software arrangements for implementing the processes and functions of the disclosure, the sections below provide details and examples of arrangements for delay-aware BSR. One or more network node 16 functions described below may be performed by one or more of processing circuitry 36, processor 38, grant scheduling unit 24, etc. One or more wireless device 22 functions described below may be performed by one or more of processing circuitry 50, processor 52, BSR unit 26, etc. As used below, wireless device 22 and WD 22 are used interchangeably below.

A delay-aware BSR framework (also referred to as delay-aware BSR) is described herein where the delay-aware BSR framework is based on a new metric of PDB_left (i.e., PDB remaining) and/or a new deadline indication in order to supplement existing short/long BSR which only considers data size and a traffic flow type. This delay-aware BSR includes time-varying PDB_left information and differentiates data in the same buffer 55 according to the information so that a network/network node 16 may make more accurate and efficient grant allocation to consider actual remaining latency information.

Some embodiments described herein can help a network to apply UL delay-aware scheduling and accurate prioritization of grant allocation between WDs 22 and data in the buffer(s) 55 having latency requirements, and can capture time-varying information of remaining latency budget to make the optimal scheduling decision instead of relying on legacy static PDB or LCG.

Some embodiments of delay-aware BSR provide for UL delay-aware scheduling when a high data rate and low latency applications are present.

A Packet Delay Budget (PDB), as used herein, may be the maximum time that can be taken to deliver a packet measured from a first point to a second point (e.g., from a sender point to a destination point). PDB may be defined as an end-to-end value, i.e., the maximum time that can be taken to deliver a packet measured from the application server to the application client, for instance. Instead of end-to-end, PDB may alternatively be measured from the point in which the packet enters the RAN until it is received by the WD 22 at a one of the RAN protocols, or when the packet is delivered from the RAN protocols to a higher layer. A packet may be, but is not limited to, an IP packet, a SDAP SDU, PDCP SDU, and/or an application data unit (ADU), for instance.

It is to be noted that, depending how PDB is measured and from which two points are taken as reference, timing information may be needed to calculate the PDB_left. PDB_left is the remaining time within which the packet should be delivered to the second point. For example, if PDB is provided end-to-end, the RAN may need to have timing related information that assists the RAN to calculate the PDB_left (maximum time RAN has to deliver that packet to the second point). In this example, the PDB_left may be: PDB (end-to-end)-elapsed time until packet reached RAN. If PDB is measured from the point the packet enters RAN until it is delivered to higher layers in the receiver side, then RAN may not require additional timing related information. As an alternative to or in addition to using PDB_left, other timing information could also be the queued time in the buffer 55, i.e., the elapsed time since the packet entered the queue.

To support a delay-aware scheduler (e.g., scheduler implemented by network node 16), a new BSR format is needed in order to provide to the network timing information about the queued packets. This timing information may be provided in different forms. It can be the time one or more packets have been queued, the time left one or more packets has against the PDB, i.e., PDB_left, or an index representing a time window such as if the one or more packets have been queued for more than a certain value and less than another value, then a specific index is indicated. The same type of table could be created for PDB_left. This is further elaborated in the following paragraphs.

When the BSR (i.e., delay-aware BSR) is triggered, the WD 22 estimates the timing information (as outlined in the paragraph above). For example purposes, the remaining PDB-PDB_left is used. The WD then estimates the PDB_left (i.e., PDB remaining) for each buffered packet in a one of the buffers, e.g., LCID or across a set of buffers, e.g., LCIDs, or across all buffers, i.e., all LCIDs. If the PDB for a certain flow is, for instance, 20 ms, the WD 22 monitors the time the packet had been queued and subtracts that from the PDB. In this example, if the packet was queued 8 ms, the PDB_left would be 12 ms. In some embodiments, the PDB_left is compared with a predefined table and/or map, e.g., a table/map stored in memory 54 and/or signaled to WD 22 by network node 16, which provides a mapping of PDB_left (e.g., PDB_left ranges, buckets, windows, etc.) to corresponding Delay Group indexes (“DGindex”). In some embodiments, each PDB_left (e.g., each PDB_left range/bucket/window/etc.) corresponds to a single DGindex. Based on this mapping, the WD 22 reports a buffer size per “DGindex” to help the network to evaluate the amount and timing of the next grant more accurately.

Alternatively, instead of providing an index, the BSR could explicitly include the calculated PDB_left. This would allow the network (e.g., network node 16) to make more accurate estimates of the timing of the delay critical data and schedule more precise grants, in time and size, since the network will know the exact time when the data meets the PDB. This however comes with the cost of overhead in signaling the BSR reports as it may require more bits to transmit a value of the PDB_left instead of just DGindexes. However, there could also be simplifications on the reported PDB_left value, to lower the required bits, as only the lower values are of interest when scheduling time critical grants. An upper bound on the reported PDB_left value could be defined so everything with a PDB_left longer than this will be reported with the max value and network considers this data as the same. In this context, a packet can be an IP packet corresponding to a SDAP or PDCP SDU/PDU, an RLC SDU, or it can also correspond to all SDUs/PDUs which are related to an Application Data Unit (ADU). One ADU is typically made of one or more IP packets.

One IP packet corresponds to one SDAP SDU, one PDCP SDU, one PDCP PDU, one RLC SDU, one or more RLC PDUs.

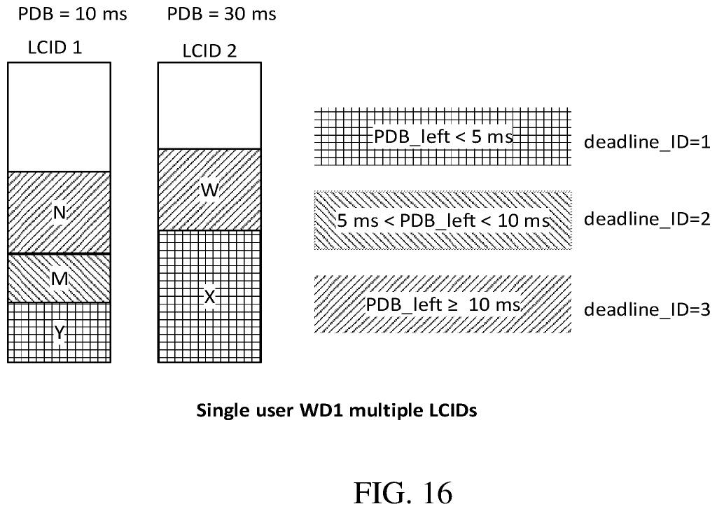

FIG. 16 is a diagram of an example scenario for the delay-aware BSR with a different “DGindex” and the grant prioritization. A WD 22 indicates it has two LCIDs in which packets arrive: LCID 1 and LCID 2. Each LCID is associated with a certain PDB. That means that to meet the QoS requirements, the time elapsed to transmit the packets should not exceed the PDB. Packets X and Y have been queued the longest and their PDB_left is the shortest. When the BSR is created, the PDB_left for these two packets is associated to (i.e., mapped to) one of the defined “DGs”. In this case, DG index is set to 1 since both packets have less than 5 ms left. Packet M has also been queued for some time and its PDB_left is between 5 and 10 ms, corresponding to DG index equal to 2. Packets N and W have been queued a period of time so that their PDB_left of 10 ms or more. These packets may be associated to DG index 3. The BSR aggregates the buffer size, i.e., it sums up the size of all the packets within a given DG and creates the BSR report. In this example, the BSR report may look like the following:

$$BSR = \{ {DG}_{3} = 1 , BS = ( X + Y ) ; {DG}_{2} = 2 , BS = ( M ) ; {DG}_{1} = 3 , BS = ( N + W ) \}$$

The network (e.g., network node 16) can then take into account the PDB_left and decide when to transmit grants and their size(s).

One difference compared to legacy BSR is that the delay-aware BSR reports the amount of data across one or more LCIDs or a set of LCIDs (i.e., LCG), which PDB or time queued in the buffer is within a certain time window. The delay-aware BSR may indicate one or more indexes and the corresponding amount of data corresponding to the reported index(es). The Legacy BSR reports the buffer size within a set of LCIDs (i.e., LCG), and the Legacy BSR provides information about the LCG index and the corresponding size. Thus, the concept of LCGs is not applicable.

The formats described in the example figures herein are only illustrative. Thus, the number of bits for each of the fields may be larger or smaller, the order of the fields may be different, or there may be additional or fewer fields (e.g., DGindexes). Depending on the number of bits and format, a “reserved” bit may also need to be introduced so the BSR is octet-aligned. However, these changes do not vary the outcome of the intended purpose of the BSR formats outlined below.

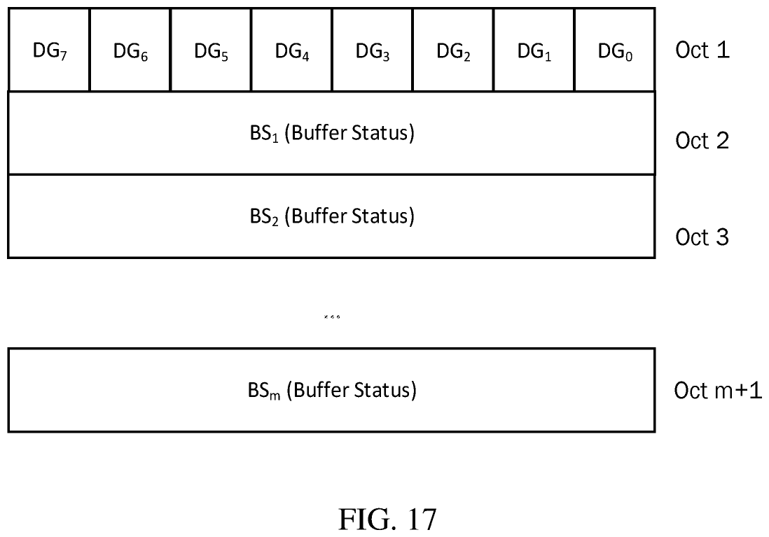

FIG. 17 shows an example of delay-aware BSR according to some embodiments of the present disclosure. In this case, the BSR provides information about the delay-groups (DG) which do have data in the queue. This could be indicated with a bitmap set or with an explicit indication of the DGindex. Additionally, the BSR provides one or more buffer statuses, one buffer status for each DG index, which indicates the presence of a buffer status (BS). In this example, the first octet (“Oct 1”) contains a bitmap in which each bit set to 1 indicates the presence or absence of the buffer status for the corresponding delay-group (DG) index. BS1 is the corresponding BS for the first DG (starting from right to left) which is set to 1. The next BS, BS2, is the buffer status corresponding to the next DG index which is set to 1. Those DG indexes set to zero do not have a corresponding BS present.

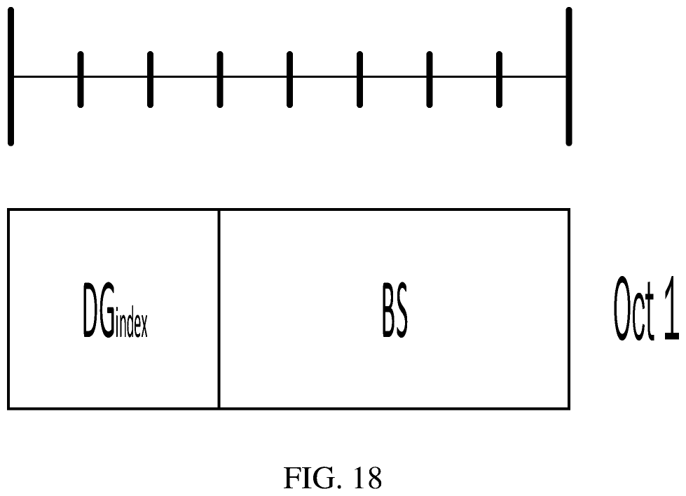

Another example BSR format according to some embodiments of the present disclosure is a shorter format that is illustrated in FIG. 18. This format indicates one DGindex and the associated BS for the given DG index. This format can be used in two different situations. On the one hand, it can be used to transmit the BS for a given DG index when all buffered data is covered within one DG index. On the other hand, it can also be used to transmit the BS for the most priority DG, i.e., the DG indicating the most urgent data in terms of latency, i.e., the data with lowest PDB_left. FIG. 18 shows that 3 bits are used to indicate the DGindex and 5 bits for the BS.

If multiple DG indexes would be needed, the structure illustrated in FIG. 18 may be repeated as many times as DG indexes would be reported, i.e., DGindex and associated buffered data for that DG index.

One or more embodiments of the present disclosure described above remove the concept of LCG or LCIDs in the BSR. However, if LCGs or LCID are reported to the network, then the BSR can report one or more LCIDs or LCGs which have data in the buffer and provide the DG indexes and the associated buffer queued in each DG for the selected LCG or LCID. In the following figures LCG and LCID could be used inter-changeably

Referring again to FIG. 16, the BSR format may include, for example:

$$BSR = \{ LCG\_ 1 : DG 3 = 1 , BS = ( Y ) ; DG 2 = 2 , BS = ( M ) ; DG 1 = 3 , \\ BS = ( N ) ; LCG 2 : DG 3 = 1 , BS = ( X ) ; DG 1 = 3 , BS = ( W ) \}$$

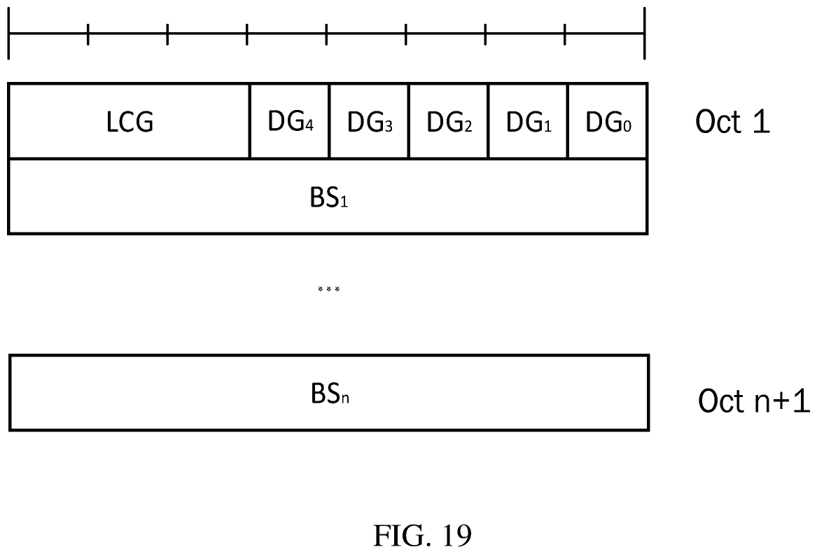

An example BSR format which can keep the concept of LCGs is a BSR format that provides both, one LCG or LCID, a set of DG indexes, and the corresponding buffer status. The LCG or LCID, whichever provided, can be explicit or implicit (e.g., bitmap as illustrated in FIG. 17). The set of DG indexes could also be explicit or implicit. An example is shown in FIG. 19. In this example and for illustrative purposes, the LCG has been used. Nevertheless, the same would apply if LCID would be used, except that the LCID, if explicitly signaled, may need more bits. In this case, therefore, a field explicitly indicating the LCG is provided as well as a bitmap of the configured delay-groups (DGs). A BS is included for each DG set to 1. Thus, there is an association between one specific DG and a buffer status. As above, one example rule is that the first DG set to 1 starting from right to left is associated with the first octet, i.e., the first instance of the buffer status. The next DG set to 1 (from right to left) may be associated to the second octet, and so on.

In cases where multiple LCIDs or LCGs are to be reported, the format in FIG. 19 can be extended so that the displayed structure (from October 1 to Oct n+1) is repeated for as many times as LCGs or LCIDs are reported. Thus, after the last BS field related to the first reported LCG/LCID, the same structure may be repeated. What LCIDs or LCGs are reported can be also preconfigured by a network (e.g., network node 16) to allocate the right size of grant for the BSR report specific to needed LCIDs or LCGs. The type of LCID or LCG can be indicated by a WD 22 by one or more methods. One example is scheduling request (SR) for the BSR can include a few extra bits to indicate. Another example is that a WD 22 can report a legacy long BSR either in a regular basis or in event-triggered basis, e.g., when a traffic arrives.

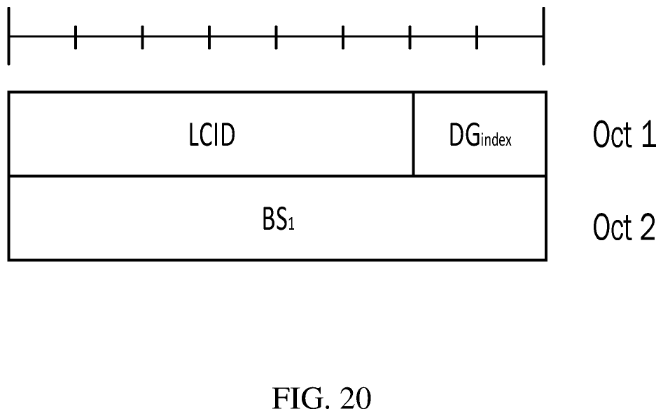

FIG. 20 is a diagram of another example. In this example, an explicit LCID and an explicit DGindex are provided followed by the buffer status corresponding to the indicated LCID and the DGindex. If multiple LCIDs are provided, the structure (Oct 1 and Oct 2) could be repeated to add additional LCIDs, for instance. If multiple DGs are provided, the format could be extended to add additional DGindex fields followed by a BS field corresponding to the associated LCID and DGindex. Alternatively, all DG fields could be explicitly provided one after another (similarly as in FIG. 19) followed by one BS field for each indicated DGindex field. Each BS field may be associated to a specific DGindex field.

As described with respect FIG. 18, when the number of bytes needs to be minimized, the BSR format illustrated in FIG. 20 could include the highest priority LCID and the DGindex field with highest urgency to be delivered, i.e., the data queued in the LCID with lowest PDB_left. Alternatively, the BSR format could include the LCID among a set of LCIDs which buffer 55 contains data having the highest urgency, i.e., the queued data with lowest PDB_left among the set of LCIDs. If multiple LCIDs are selected, the highest priority LCID may be indicated. Alternatively to the highest priority LCID, the LCID with the most buffered data (e.g., highest quantity of buffered data) having the lowest PDB_left is then reported.

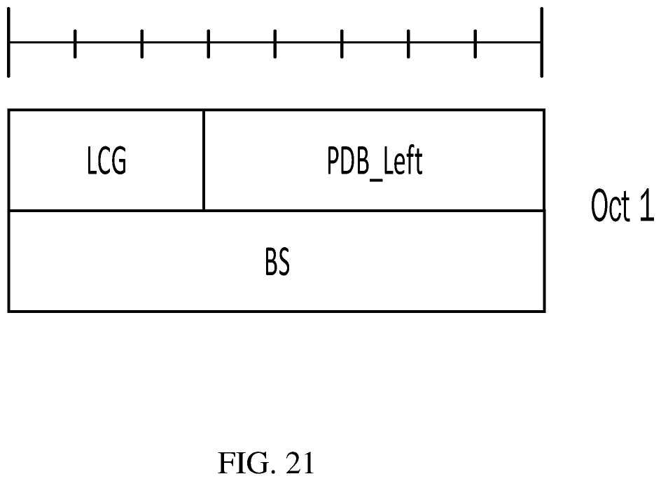

In another example, BSR format explicitly includes the PDB_left instead of DGindex. As in the DG index cases described above this could be performed in various ways but one such example is presented in FIG. 21. In FIG. 21, Oct 1 provides LCG, a value for PDB_left and the corresponding buffer status. The granularity and range of values for PDB_left could be limited based on the number of bits available in the BSR. One use case of a format explicitly indicating the PDB_left could be when there is only data with the same PDB_left in the buffer. In this case there may be no need to use multiple Delay Groups and the bits in the BSR report could be used for the more precise reporting.

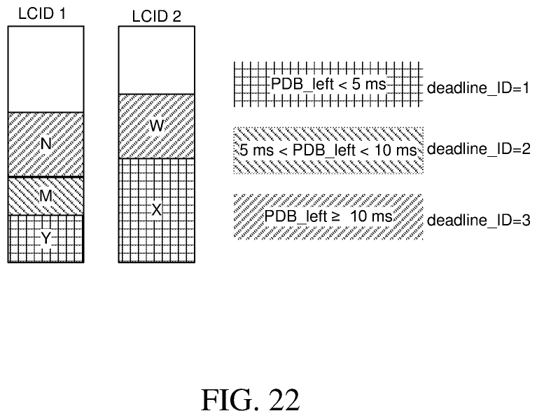

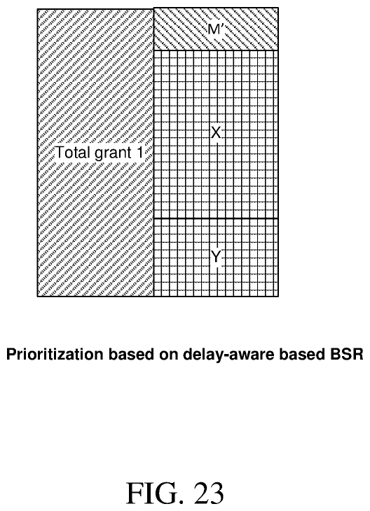

FIGS. 22 and 23 provide illustrations of single user (e.g., a WD 22 with multiple flows LCID 1 and LCID 2) prioritization based on delay-aware BSR. When a network node 16 receives the BSR, the network node 16 may consider some/all queued data packets and associated delay information from the multiple flows to identify the most urgent data packet(s) to be delivered. For example, “urgent” may refer to packets that need to be transmitted sooner than other packets.

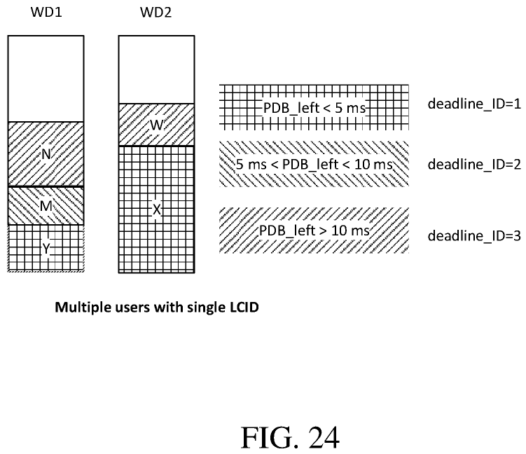

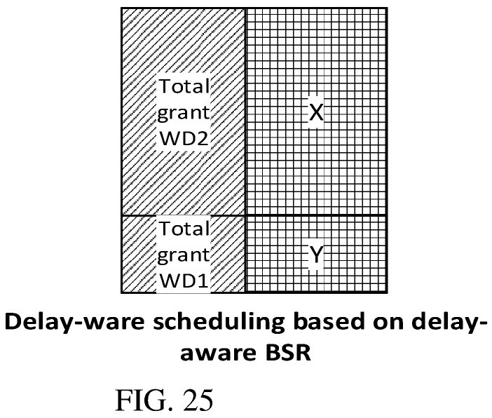

FIGS. 24 and 25 provide an illustration of multiple user prioritization based on delay-aware BSR. When a network node 16 receives the BSR, the network node 16 may consider some/all queued data packets and associated delay information from multiple WDs 22 in a serving cell to identify the most urgent WD 22 which has the most urgent packet(s) to be delivered. For example, “urgent” may refer to packets that need to be transmitted sooner than other packets.

The WD 22 may report to the network node 16 that the WD 22 supports the delay-aware BSR and related functionality. The network node 16 may then configure the WD 22 to use the delay-aware BSR and related functionality. This may be configured, for example, via RRC signaling using, for example, one explicit bit in the configuration such as:
delay AwareBSR enumerated {true} OPTIONAL,

In scenarios in which different LCIDs carry different traffic, the use of delay-aware BSR may also be configurable for each individual LCID.

The use of delay-aware BSR and its related functionality could also be implicitly configured by including one or more parameters to configure the functionality, e.g., delay-groups, or thresholds. Similarly, these parameters could be provided individually per each LCIDs or could apply to all LCIDs which are configured to use delay-aware BSR. As an example, RRC signaling from the network node 16 could provide a list of delay groups. The presence of this list may implicitly indicate to the WD 22 the use of the delay-aware BSR and its functionality. In case the solution above is used, the delay groups could, instead, be mandatory present information element (IE) when the first IE (delayAwareBSR) is present.

delayGroupsList SEQUENCE (SIZE (1.. maxDelayGroupsList)) OF
delayGroups OPTIONAL

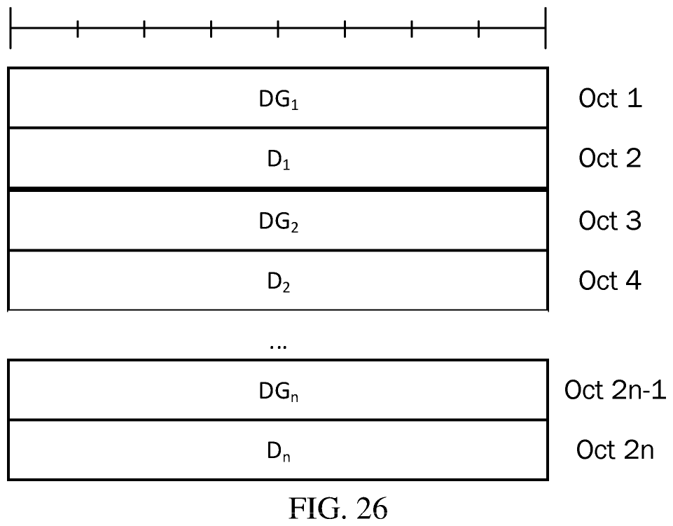

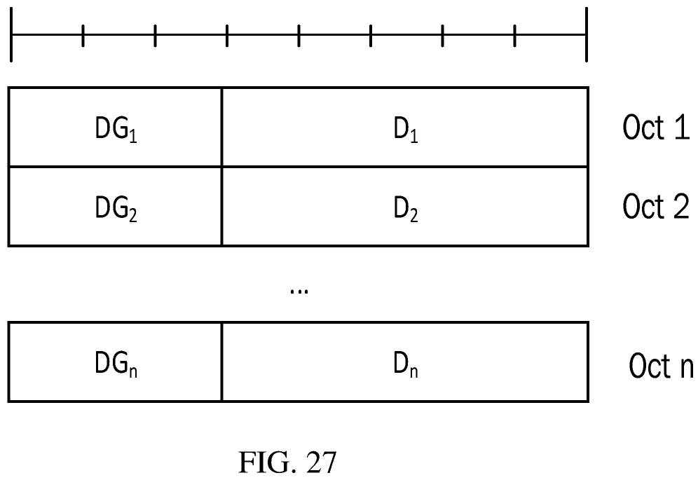

Each delay group may represent a range of remaining PDB of the packets within the group. The exact sizes of each delay group may be configured by the network node 16. For example, this could be configured through an RRC message, a MAC Control Element, PHY signaling, or similar signaling, which provides information regarding the remaining PDB threshold for each group. FIGS. 26 and 27 depict example MAC CE configuration messages, where each delay group is associated with a delay D, which may, for example, be expressed in milliseconds. A WD 22 groups its packets so each packet will belong to a delay group n if its remaining PDB is within the delay D1+D2+ . . . +Dn-1 and D1+D2+ . . . +Dn-1+Dn, and packets belong to DG1 if its remaining delay is between 0 and D1. Note that these figures are merely example, and the exact number of bits for each field or the chosen time unit may change without deviating from the scope of the present disclosure.

### Some Examples

Example A1. A network node 16 configured to communicate with a wireless device (WD) 22, the network node 16 configured to, and/or comprising a radio interface 30 and/or comprising processing circuitry 36 configured to:
receive a buffer status report from the WD 22, the buffer status report being based on:
   a queue duration of at least one queued data packet; and
   a packet data buffer (PDB) duration of a logical channel associated with the at least one queued data packet; and
determine a scheduling grant to the WD 22 based on the buffer status report.

Example A2. The network node 16 of Example A1, wherein:
the buffer status report includes at least one delay group index, each of the at least one delay group index being associated with:
   at least one time value; and
   at least one queued data packet.

Example A3. The network node 16 of Example A2, wherein the buffer status report includes a corresponding buffer status parameter for each of the at least one delay group index, the buffer status parameter being based on a total size of queued data packets associated with each of the at least one delay group index.

Example A4. The network node 16 of Example A3, wherein the scheduling grant is based on the total size of queued data packets associated with the delay group index having a lowest time value.

Example B1. A method implemented in a network node 16 that is configured to communicate with a wireless device (WD) 22, the method comprising:
receiving a buffer status report from the WD 22, the buffer status report being based on:
   a queue duration of at least one queued data packet; and
   a packet data buffer (PDB) duration of a logical channel associated with the at least one queued data packet; and
determining a scheduling grant to the WD 22 based on the buffer status report.

Example B2. The method of Example B1, wherein the buffer status report includes at least one delay group index, each of the at least one delay group index being associated with:
at least one time value; and
at least one queued data packet.

Example B3. The method of Example B2, wherein the buffer status report includes a corresponding buffer status parameter for each of the at least one delay group index, the buffer status parameter being based on a total size of queued data packets associated with each of the at least one delay group index.

Example B4. The method of Example B3, wherein the scheduling grant is based on the total size of queued data packets associated with the delay group index having a lowest time value.

Example C1. A wireless device (WD) 22 configured to communicate with a network node 16, the WD 22 configured to, and/or comprising a radio interface 46 and/or processing circuitry 50 configured to:
determine a queue duration for at least one of a plurality of queued data packets, each of the plurality of queued data packets being associated with a logical channel of a plurality of logical channels, each of the plurality of logical channels being associated with a packet data buffer (PDB) duration; and
send a buffer status report to the network node 16, the buffer status report being based on:
   the determined queue duration of the at least one queued data packet; and
   the PDB duration of the logical channel associated with the at least one queued data packet.

Example C2. The WD 22 of Example C1, wherein the buffer status report includes at least one delay group index, the at least one delay group index being associated with at least one time value.

Example C3. The WD 22 of Example C2, wherein the WD 22 and/or radio interface 46 and/or processing circuitry 50 is/are further configured to:
associate the at least one queued data packet to a corresponding delay group index, the associating including:
   determining a difference between the queue duration of the at least one queued data packet and the PDB duration of the logical channel associated with the at least one queued data packet;
   comparing the difference to the at least one time value of at least one delay group index; and
   mapping the at least one queued data packet to a delay group index based on the comparison.

Example C4. The WD 22 of Example C3, wherein for each delay group index included in the buffer status report, the buffer status report includes a corresponding buffer status parameter, the buffer status parameter being based on a total size of queued data packets associated with the delay group index.

Example C5. The WD 22 of any one of Examples C1, C2, C3, and/or C4, wherein the buffer status report includes at least one of: a logical channel indication and a logical channel group indication.

Example D1. A method implemented in a wireless device (WD) 22 that is configured to communicate with a network node 16, the method comprising:
determining a queue duration for at least one of a plurality of queued data packets, each of the plurality of queued data packets being associated with a logical channel of a plurality of logical channels, each of the plurality of logical channels being associated with a packet data buffer (PDB) duration; and
sending a buffer status report to the network node 16, the buffer status report being based on:
   the determined queue duration of the at least one queued data packet; and
   the PDB duration of the logical channel associated with the at least one queued data packet.

Example D2. The method of Example D1, wherein the buffer status report includes at least one delay group index, the at least one delay group index being associated with at least one time value.

Example D3. The method of Example D2, further comprising:
associating the at least one queued data packet to a corresponding delay group index, the associating including:
determining a difference between the queue duration of the at least one queued data packet and the PDB duration of the logical channel associated with the at least one queued data packet;
comparing the difference to the at least one time value of at least one delay group index; and
mapping the at least one queued data packet to a delay group index based on the comparison.

Example D4. The method of Example D3, wherein for each delay group index included in the buffer status report, the buffer status report includes a corresponding buffer status parameter, the buffer status parameter being based on a total size of queued data packets associated with the delay group index.

Example D5. The method of any one of Examples D1, D2, D3, and/or D4, wherein the buffer status report includes at least one of: a logical channel indication and a logical channel group indication.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

### ABBREVIATIONS THAT MAY BE USED IN THE PRECEDING DESCRIPTION INCLUDE

ADU Application Data Unit
AR Augmented Reality
ARP Allocation and Retention Priority
AS Access Stratum
BSR Buffer Status Report
DG Delay group
DL Downlink
DRB Data Radio Bearer
eMBB Enhanced Mobile Broadband
Fps Frames Per Second
IP Internet Protocol
LCG Logical Channel Group
LCID Logical Channel Identity
mMTC Massive Machine Type Communications
MR Mixed Reality
NAS Non-access Stratum
NR New Radio
PDB Packet Delay Budget
PDR Packet Detection Rules
PDU Protocol Data Unit
QFI QoS Flow ID
QOS Quality of Service
RAN Radio Access Network
SDAP Service Data Adaptation Protocol
SDU Service Data Unit
SMF Session Management Function
TB Transport Block
TTI Transmission Time Interval
UL Uplink
UPF User Plane Function
URLLC Ultra-reliable low-latency communications
VOIP Voice over IP
VR Virtual Reality
xR extended Radio

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device (WD), the network node comprising processing circuitry configured to:
receive a buffer status report from the WD, the buffer status report including queue information for a first protocol data unit set, the first PDU set including at least one queued packet;
determine a scheduling grant for the WD based on the queue information and at least one packet delay budget left value associated with the first PDU set;
cause transmission of the scheduling grant to the WD; and
receive at least one uplink transmission of the at least one queued packet from the WD according to the scheduling grant.

2. The network node of claim 1, wherein the at least one PDB left value corresponds to a difference between at least one queue duration of the at least one queued packet and at least one PDB associated the first PDU set.

3. The network node of of claim 1, wherein the queue information included in the buffer status report includes at least one of:
at least one queue duration corresponding to the at least one queued packet;
at least one PDB left value associated with the at least one queued packet;
at least one PDB left value associated with the first PDU set;
at least one delay group index associated with the at least one queued packet, the at least one delay group index corresponding to at least one range of PDB left values; and or
at least one total packet size value associated with the at least one delay group index.

4. The network node of claim 3, wherein the buffer status report includes a corresponding buffer status parameter for each of the at least one delay group index, the buffer status parameter being based on a total size of queued packets associated with each of the at least one delay group index.

5. The network node of claim 3, wherein the scheduling grant is based on the total size of queued packets associated with the delay group index having a lowest time value.

6. The network node of claim 1, wherein the processing circuitry is further configured to receive at least one other buffer status report from at least one other WD; and
the determining of the scheduling grant for the WD being further based on the at least one other buffer status report and at least one packet delay budget (PDB) left value associated with at least one PDU set of the at least one other WD.

7. The network node of claim 1, wherein the at least one PDB is associated with at least one of:
at least one logical channel;
at least one buffer; or
at least one quality of service, QOS, requirement.

8. A method implemented in a network node configured to communicate with a wireless device (WD), the method comprising:
receiving a buffer status report from the WD, the buffer status report including queue information for a first protocol data unit (PDU) set, the first PDU set including at least one queued packet;
determining a scheduling grant for the WD based on the queue information and at least one packet delay budget (PDB) left value associated with the first PDU set;
causing transmission of the scheduling grant to the WD; and
receiving at least one uplink transmission of the at least one queued packet from the WD according to the scheduling grant.

9. The method of claim 8, wherein the at least one PDB left value corresponds to a difference between at least one queue duration of the at least one queued packet and at least one PDB associated the first PDU set.

10. The method of claim 8, wherein the queue information included in the buffer status report includes at least one of:
at least one queue duration corresponding to the at least one queued packet;
at least one PDB left value associated with the at least one queued packet;
at least one PDB left value associated with the first PDU set;
at least one delay group index associated with the at least one queued packet, the at least one delay group index corresponding to at least one range of PDB left values; and or
at least one total packet size value associated with the at least one delay group index.

11. The method of claim 10, wherein the buffer status report includes a corresponding buffer status parameter for each of the at least one delay group index, the buffer status parameter being based on a total size of queued packets associated with each of the at least one delay group index.

12. The method of claim 10, wherein the scheduling grant is based on the total size of queued packets associated with the delay group index having a lowest time value.

13. The method of claim 8, wherein the method further comprises receiving at least one other buffer status report from at least one other WD; and
the determining of the scheduling grant for the WD being further based on the at least one other buffer status report and at least one packet delay budget (PDB) left value associated with at least one PDU set of the at least one other WD.

14. The method of claim 8, wherein the at least one PDB is associated with at least one of:
at least one logical channel;
at least one buffer; or
at least one quality of service, QoS, requirement.

15. A wireless device (WD) configured to communicate with a network node, the WD comprising processing circuitry configured to:
determine a buffer status report, the buffer status report including queue information for a first protocol data unit (PDU) set, the first PDU set including at least one queued packet;
receive, from the network node, a scheduling grant based on the queue information and at least one packet delay budget (PDB) left value associated with the first PDU set; and
cause transmission of at least one uplink transmission of the at least one queued packet according to the scheduling grant.

16. The WD of claim 15, wherein the at least one PDB left value corresponds to a difference between at least one queue duration of the at least one queued packet and at least one PDB associated with the first PDU set.

17. The WD of claim 15, wherein the queue information included in the buffer status report includes at least one of:
at least one queue duration corresponding to at least one queued packet;
at least one PDB left value associated with the at least one queued packet;
at least one PDB left value associated with the first PDU set;
at least one delay group index associated with the at least one queued packet, the at least one delay group index corresponding to at least one range of PDB left values; or
at least one total packet size value associated with the at least one delay group index.

18. The WD of claim 17, wherein the buffer status report includes a corresponding buffer status parameter for each of the at least one delay group index, the buffer status parameter being based on a total size of queued packets associated with each of the at least one delay group index.

19. The WD of claim 15, wherein the scheduling grant for the WD is based on at least one other buffer status report associated with at least one other WD and at least one packet delay budget (PDB) left value associated with at least one PDU set of the at least one other WD.

20. The WD of claim 15, wherein the at least one PDB is associated with at least one of:
at least one logical channel;
at least one buffer; or
at least one quality of service, QoS, requirement.

21. A method implemented by a wireless device (WD) configured to communicate with a network node, the method comprising:
determining a buffer status report, the buffer status report including queue information for a first protocol data unit (PDU) set, the first PDU set including at least one queued packet;
receiving, from the network node, a scheduling grant based on the queue information and at least one packet delay budget (PDB) left value associated with the first PDU set; and
causing transmission of at least one uplink transmission of the at least one queued packet according to the scheduling grant.

22. The method of claim 21, wherein the at least one PDB left value corresponds to a difference between at least one queue duration of the at least one queued packet and at least one PDB associated with the first PDU set.

23. The method of claim 21, wherein the queue information included in the buffer status report includes at least one of:
at least one queue duration corresponding to at least one queued packet;
at least one PDB left value associated with the at least one queued packet;
at least one PDB left value associated with the first PDU set;
at least one delay group index associated with the at least one queued packet, the at least one delay group index corresponding to at least one range of PDB left values; and or
at least one total packet size value associated with the at least one delay group index.

24. The method of claim 23, wherein the buffer status report includes a corresponding buffer status parameter for each of the at least one delay group index, the buffer status parameter being based on a total size of queued packets associated with each of the at least one delay group index.

25. The method of claim 21, wherein the scheduling grant for the WD is based on at least one other buffer status report associated with at least one other WD and at least one packet delay budget (PDB) left value associated with at least one PDU set of the at least one other WD.

26. The method of claim 21, wherein the at least one PDB is associated with at least one of:
at least one logical channel;
at least one buffer; or
at least one quality of service, QOS, requirement.
